(19) United States
(12) Patent Application Publication
(10) Pub. No.: US 2006/0009536 A1
(43) Pub. Date: Jan. 12, 2006

(54) Functionalized sol-gel material, sol-gel film derived therefrom, and method for preparing the same

(76) Inventors: Guang-Way Jang, Hsinchu City (TW); Ya-Hui Lin, Hsinchu City (TW); I-Chia Tsai, Pingtung City (TW); Pei Tien, Kaohsiung City (TW); Yuung-Ching Sheen, Chu Pei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/889,306

(22) Filed: Jul. 12, 2004

(51) Int. Cl. B01J 13/00; C08J 3/02

(52) U.S. Cl. 516/100

(57) ABSTRACT

A method of preparing a sol-gel material is described. A metal alkoxide and an organically modified Si-alkoxide having a predetermined functional group are dissolved in a first solvent and a second solvent to form a first solution and a second solution, respectively. The first solution and the second solution are then mixed and heated. As a result, the metal alkoxide reacts with the organically modified Si-alkoxide, and a functionalized sol-gel material is formed thereby. Furthermore, the solid content of the functionalized sol-gel material is increased by transferring the same into another solvent. Therefore, a thick sol-gel film is fabricated by means of the transferred functionalized sol-gel material.

### FIELD OF THE INVENTION

The present invention relates to a sol-gel material, and more particularly, to a functionalized sol-gel material, a method of preparing the same, and a sol-gel film derived therefrom.

### BACKGROUND OF THE INVENTION

Organic-inorganic hybrid materials possess not only the advantages of organic materials, such as processibility and flexibility, but also the advantages of inorganic materials, like high mechanical strength and high thermal properties, and hence are studied internationally and are widely applied in various fields. In general, a hybrid material is prepared by mixing an organic material and an inorganic material, which are associated by molecular forces therebetween, such as, for example, London-van der Waals force or hydrogen bonding, on a nanometer scale. Therefore, the hybrid material is formed without phase separation in the macroscopic view, and further combines the properties of the organic material and the inorganic material.

Due to the poor thermal properties of organic materials, organic-inorganic hybrid materials cannot be prepared in a conventional ceramic-manufacturing process. Instead, a sol-gel process is usually adopted to fabricate organic-inorganic hybrid materials. Sol-gel process including a hydrolysis step and a condensation step performed at a low temperature. Consequently, organic materials can be introduced into inorganic materials without degradation.

The organic-inorganic hybrid materials prepared by the sol-gel process, however, are easily influenced by surrounding conditions, such as, for instance, temperature or humidity. As a result, the organic-inorganic sol-gel materials tend to age, which decreases the shelf life thereof. Additionally, the organic-inorganic sol-gel materials with a nanometer dimension incline to aggregate with one another. To stabilize the properties and the sizes of the organic-inorganic sol-gel materials, chelating agents are required in preparing the same. The chelating agents are, for example, methacrylic acid, acetic acid, and acetyl acetone.

On the other hand, the solid content of the organic-inorganic sol-gel materials prepared by the sol-gel process is usually around 20% to 30%, of which the viscosity is not high enough for preparing a thick sol-gel film. Unfortunately, raising the solid content by increasing reaction time and reactant concentrations directly results in gelation of the organic-inorganic sol-gel materials. Moreover, phase separation occurs if the viscosity of the organic-inorganic sol-gel materials is increased by adding another polymer solution with higher viscosity.

### SUMMARY OF THE INVENTION

It is the objective of the present invention to provide a method of preparing a functionalized sol-gel material without using chelating agents. The functionalized sol-gel material is stable on a nanometer scale, through which a thick sol-gel film is further fabricated.

According to the aforementioned objective of the present invention, on the one hand, a functionalized organic-inorganic sol-gel material and a preparation method thereof are provided. An organic material and an inorganic material are separately mixed with corresponding solvents, followed by mixing the solvents and heating the same for a period of time to form a sol-gel material. The inorganic material is a metal alkoxide of which the un-saturation degree of the metal atom therein is greater than zero, while the organic material is an organically modified Si-alkoxide. The interaction between the sol-gel materials is effectively reduced, which prevents the sol-gel materials from aggregating with one another, by selecting proper solvents at the beginning of preparation. Therefore, the functionalized organic-inorganic sol-gel material with a stable nanometer dimension is formed by means of the selected solvents instead of any chelating agents.

According to the aforementioned objective of the present invention, on the other hand, a method for preparing a thick sol-gel film derived from a functionalized sol-gel material is provided. The solid content of a functionalized sol-gel material is dramatically raised by transferring the sol-gel material into a selected solvent. A thick and uniform film is then formed more easily, since the solid content of the sol-gel material has been increased. Hence, the sol-gel material after being transferred can be used to fabricate directly a thick film with no need of other adhesives, like polymer solution with higher viscosity.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 illustrates a flowchart of preparing a functionalized sol-gel material in accordance with a preferred embodiment of the present invention;

FIG. 2 illustrates an infrared spectrum of the functionalized sol-gel material prepared according to FIG. 1;

FIG. 3 shows a TEM picture of the functionalized sol-gel material prepared according to FIG. 1; and

FIG. 4 illustrates a flowchart of preparing a thick sol-gel film in accordance with another preferred embodiment of the present invention.

### DETAILED DESCRIPTION OF THE PREFERRED EMBODIMENTS

It is found that an organic-inorganic sol-gel material with a stable dimension on a nanometer scale is prepared with no need of chelating agents, if the stability of a reactive solution is properly controlled according to the following equations at the beginning of preparation.

$$\begin{matrix}{V}_{att} = - \frac{{A}_{13}}{12} H ( x , y ) & ( 1 ) \\ {A}_{13} = \frac{3}{4} {kT [ \frac{ɛ 1 - ɛ 3}{ɛ 1 + ɛ 3} ]}^{2} + \frac{3 h {v}_{e}}{16 \sqrt{2}} \cdot \frac{{( {n}_{1}^{2} - {n}_{3}^{2} )}^{2}}{{( {n}_{1}^{2} + {n}_{3}^{2} )}^{3 / 2}} & ( 2 )\end{matrix}$$

Equation (1) represents the attraction energy (Vₐₜₜ) between two spherical particles (medium 1) dispersed in a medium 3, where A₁₃ is the Hamaker constant and H(x, y) is the Hamaker function, which depends on the inter-particle distance and on the particle radius. An approximate expression for A₁₃ is given by equation (2), where ε1 and ε3 are the dielectric constants of the media, n₁ and n₃ are their refractive indexes in the visible range, νₑ is the absorption frequency of the media assumed to be the same for both of them, k is the Boltzmann constant (1.38×10⁻²³ J·K⁻¹), T is the absolute temperature, and h is the Planck's constant (6.626×10⁻³⁴ J·s).

According to these equations, the interaction between particles is dependent on the properties of a medium where the particles are dispersed. Consequently, the attraction energy between particles is reduced if an adequate medium is selected; the particles are thus less attracted to one another and aggregate less. Therefore, particles with stable dimensions are obtained without using any chelating agents. By this principle, a functionalized sol-gel material, a method for preparing the same, and a thick sol-gel film derived therefrom in accordance with the preferred embodiments of the present invention are disclosed in detail as follows, taken in conjunction with the accompanying drawings.

### Embodiment 1

One aspect of the present invention is to provide a metal alkoxide and an organically modified Si-alkoxide having a predetermined functional group as precursors to form a functionalized sol-gel material. Additionally, solvents are selected according to the principle mentioned above before preparing the material. As a result, stable reactive surroundings for the material are provided at the beginning of preparation.

The metal alkoxide can be formulated as M(OR)ₓ, where M is a metal atom, x is the valence of M, and R represents C₁-C₁₂ alkyl. Further, the un-saturation degree of the metal atom (i.e. the difference between the coordination number and the valence of M) is greater than zero. The metal atom is, for example, titanium (Ti), zirconium (Zr), germanium (Ge), tin (Sn), or cerium (Ce). The aforesaid metal alkoxide may be zirconium butoxide (Zr(OBu)₄) or zirconium proxide (Zr(OPr)₄), and is preferably zirconium butoxide in the embodiment. Furthermore, the organically modified Si-alkoxide can be expressed as R¹Si(OR)₃ or R¹R²Si(OR)₂, where R represents C₁-C₁₂ alkyl, and R¹ and R² are hydrocarbyl groups that may be different or the same. The predetermined functional group (R¹ or R²) may be an epoxy group or an amine group (—NH), or an unsaturated functional group, such as a vinyl group, an acryl group, or a photosensitive derivative thereof. Moreover, methacryloxypropyl tri-methoxysilane (MPTMS) is preferably used in the embodiment.

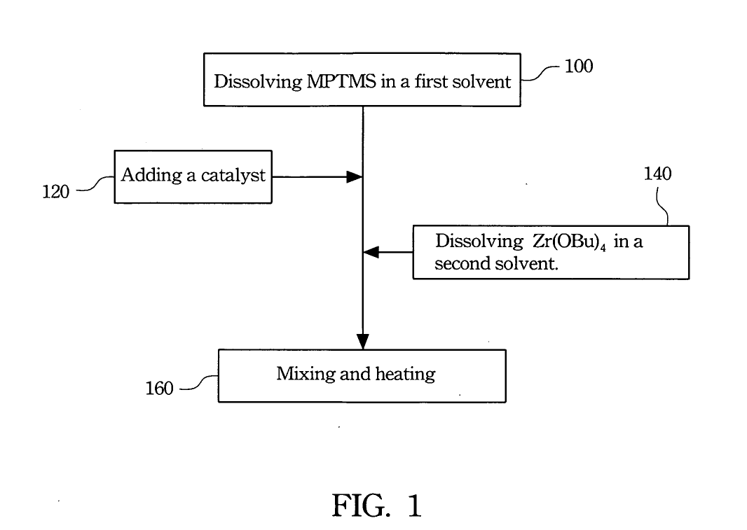

Reference is made to FIG. 1, which illustrates a flowchart of the process of preparing a functionalized sol-gel material in accordance with the embodiment. According to step 100, MPTMS of about 15 g (about 0.06 mole) is dissolved in a first solvent of about 30 g to form a first solution, which is then stirred about 30 to 60 minutes. A catalyst is further added to the first solution for aiding the hydrolysis of the MPTMS, in step 120. In the preferred embodiment, the catalyst is 0.1N hydrochloride solution (HCl). In step 140, a second solution is formed by dissolving zirconium butoxide in a second solvent and stirring the second solution for around 10 to 30 minutes. The first solution and the second solution are next mixed and heated for a period of time in step 160. Generally, the temperature to which the solutions are heated is slightly lower than the boiling points of the solvents. Moreover, the first solvent may be the same as the second solvent, and hence the reaction is controlled more easily. In the preferred embodiment of the present invention, the first solvent and the second solvent are both tetra-hydrofuran (THF), and the heating temperature is around 65° C.

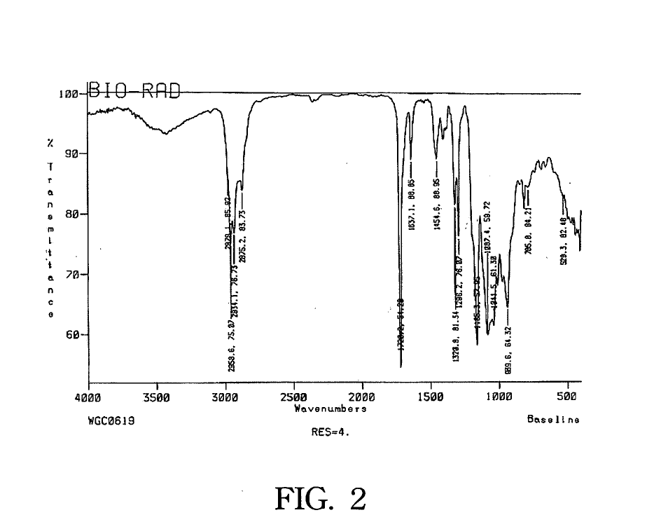

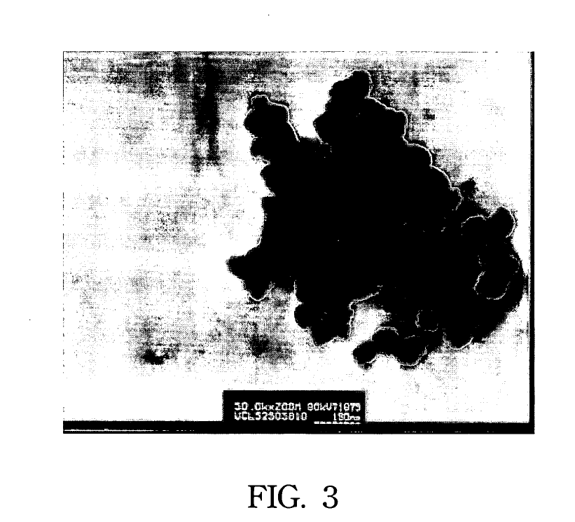

The resultant material is a transparent solution, which also implies that the resultant particles are on a nanometer (nm) scale and are well dispersed in the solvents. The Fourier Transformation infrared (FTIR) spectrum of the particles is shown in FIG. 2. The absorption band at around 1600 cm⁻¹ and around 1730 cm⁻¹ are due to the C═C stretching mode and the C═O stretching mode of MPTMS, respectively. The absorption band at about 840 cm⁻¹ is assigned to Zr—O—Si bonding. On this ground, a sol-gel material/particle having a photosensitive group is prepared. FIG. 3 is the transmission electron microscopy (TEM) picture of the particles, which further proves that the size of the resultant particles is smaller than 100 nm, and that the particle size distribution is uniform.

Further, the attraction energy (A₁₃) of THF as calculated by the aforementioned equation (2) is 11.1 or so. As a result, the interaction between the particles is decreased by THF, which prevents the particles from attracting one another and aggregating. Therefore, a sol-gel particle with stable dimensions is prepared through adequate solvents. Moreover, THF is only an exemplary solvent, and is not intended to limit the invention. Other solvents that provide stable reactive surroundings, for instance, toluene (A₁₃ is about 12.1) or propylene glycol monoether acetate (PMAc) (A₁₃ is about 9.6), are also used to prepare an organic-inorganic sol-gel material with stable dimensions.

On the other hand, the aforenamed precursors and the proportions thereof are merely in favor of illustrating the embodiment. It is appreciated that any substitutes, although not described or shown herein, which embody the principles of the invention, are included within the spirit and scope of the invention. For instance, a sol-gel material having an epoxy group on a nanometer scale is formed through 3-glycidoxypropyl trimethoxysilane (GLYMO), in the case where solvents are appropriately selected at the beginning of preparation.

### Embodiment 2

### Comparative Example

In this embodiment, an organic-inorganic sol-gel material is formed in alcohol under the same preliminary conditions as those in embodiment 1. The material in alcohol is further compared with materials formed in different solvents, which results are listed in Table 1.

TABLE 1
Comparative results of various materials
formed in different solvents

| | Dielectric | | | |
|---|---|---|---|---|
| | constant of | Attraction energy | Particle size | Solution |
| Solvent | solvent | (A₁₃) | (nm) | condition |
| THF | 7.6 | 11.1 | <100 | Transparent |
| Toluene | 2.2 | 12.1 | <100 | Transparent |
| PMAc | 6.7 | 9.6 | <100 | Transparent |
| Alcohol | 25.7 | 1.1 | >5000 | Opaque |

It is found from Table 1 that, a transparent solution and nano-particles are obtained if an adequate solvent is selected. Consequently, particles attract one another and aggregate less, and thus have stable sizes, because solvents decrease the interaction between particles. On the contrary, larger particles are given in alcohol, and the resultant solution is opaque. Furthermore, the dielectric constant of solvents is preferably smaller than 10.

### Embodiment 3

For preparing a thick sol-gel film, the solid content of a sol-gel material is increased by transferring the same into another solvent in accordance with the present invention. The sol-gel material of Embodiment 1 herein is only an example to describe the process for convenience, which is not proposed to limit the invention.

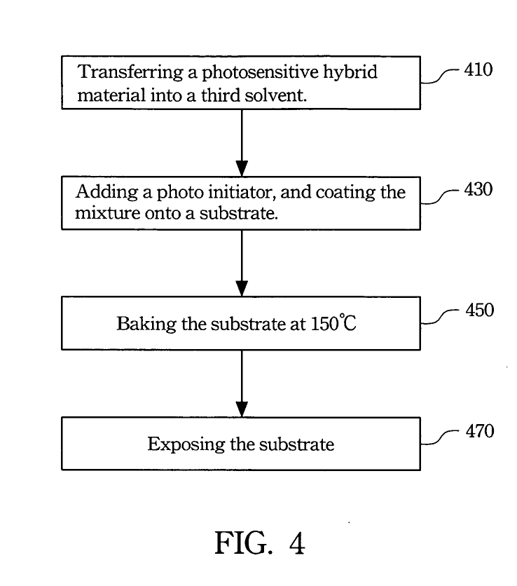

Reference is made to FIG. 4, which illustrates a flowchart of preparing a thick sol-gel film according to the embodiment. The photosensitive sol-gel material of Embodiment 1 is first transferred into a third solvent, in step 410. The boiling point of the third solvent is smaller than those of the first solvent and the second solvent. Additionally, the amount of the third solvent is less than the total amount of the first solvent and the second solvent. As a result, the first solvent and the second solvent are removed by heating, and the sol-gel material remains in the third solvent. Therefore, the solid content of the sol-gel material is increased. The third solvent is determined by its compatibility with an applied substrate, and is preferably propylene glycol monoether acetate in this embodiment. Then, in step 430, a photo initiator is mixed in the transferred third solvent, and the mixture is coated onto a substrate thereafter. The substrate is next baked at around 150° C. in step 450, and is exposed in step 470. Hence, the photosensitive sol-gel material on the substrate is further cross-linked thoroughly, and a thick sol-gel film is thus derived. The thickness of the sol-gel film is up to 10 μm and above, when the solid content of the sol-gel material is raised to about 50%.

A thick and uniform sol-gel film is derived directly from a transferred sol-gel material in accordance with the embodiment. Consequently, no binder is required, and no phase separation occurs. Additionally, the thickness of a sol-gel film can be controlled by adjusting the solid content of a sol-gel material. Further, the transmission of the sol-gel film coated on a glass is above 90% in the visible range of 400 nm to 700 nm and at wavelengths of 1310 nm and 1550 nm. The baking temperature or species of the initiator and the third solvent are exemplary descriptions only, and are not proposed to limit the invention.

According to the aforementioned preferred embodiments of the present invention, a functionalized organic-inorganic sol-gel material is prepared without any chelating agents in selected solvents. The resultant sol-gel particles are on a nanometer scale, and are stably dispersed in the selected solvents. On the other hand, a thick sol-gel film is fabricated by means of the sol-gel material of which solid content is effectively increased by transferring the same into another solvent.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A method for preparing a functionalized sol-gel material, comprising the steps of:
dissolving a metal alkoxide in a first solvent to form a first solution free of a chelating agent, wherein the metal alkoxide is formulated as M(OR)x, wherein M represents a metal atom with an un-saturation degree greater than zero, x is a valence of M, and R is a C1-C12 alkyl;
dissolving an organically modified Si-alkoxide and a catalyst in a second solvent to form a second solution;
mixing the first solution and the second solution to form a mixture; and
heating the mixture to react the metal alkoxide with the organically modified Si-alkoxide to form a functionalized sol-gel material, wherein the first solvent and the second solvent further stabilize the functionalized sol-gel material, and hence prevent the functionalized sol-gel material from aggregating with one another.

2. The method of claim 1, wherein the metal atom (M) is selected from a group consisting of titanium (Ti), zirconium (Zr), germanium (Ge), tin (Sn), and cerium (Ce).

3. The method of claim 2, wherein the metal alkoxide comprises zirconium butoxide or zirconium proxide.

4. The method of claim 1, wherein the organically modified Si-alkoxide further comprises an unsaturated functional group.

5. The method of claim 4, wherein the unsaturated functional group comprises a vinyl group, an acryl group, or a photosensitive derivative thereof.

6. The method of claim 5, wherein the organically modified Si-alkoxide is methacryloxypropyl tri-methoxysilane.

7. The method of claim 1, wherein the organically modified Si-alkoxide further comprises an epoxy group or an amine group.

8. The method of claim 7, wherein the organically modified Si-alkoxide is 3-glycidoxypropyl tri-methoxysilane.

9. The method of claim 1, wherein the first solvent and the second solvent are identical, and the dielectric constants of the first solvent and the second solvent are smaller than about 10.

10. The method of claim 9, wherein the first solvent and the second solvent comprise tetra-hydrofuran, toluene, or propylene glycol monoether acetate.

11. A method of preparing a thick sol-gel film, comprising the steps of:
dissolving a metal alkoxide in a first solvent to form a first solution free of a chelating agent, wherein the metal alkoxide is formulated as M(OR)ₓ, wherein M represents a metal atom with an un-saturation degree greater than zero, x is a valence of M, and R is a C₁-C₁₂ alkyl;
dissolving an organically modified Si-alkoxide and a catalyst in a second solvent to form a second solution;
mixing the first solution and the second solution to form a mixture;
heating the mixture to react the metal alkoxide with the organically modified Si-alkoxide to form a functionalized sol-gel material, wherein the first solvent and the second solvent further stabilize the functionalized sol-gel material, and hence prevent the functionalized sol-gel material from aggregating with one another; and
transferring the functionalized sol-gel material into a third solvent, wherein a boiling point of the third solvent is higher than boiling points of the first solvent and the second solvent.

12. The method of claim 11, further comprising the steps of:
adding an initiator to the third solvent to form another mixture;
coating the mixture with the initiator onto a substrate; and
baking the substrate.

13. The method of claim 11, wherein the organically modified Si-alkoxide further comprises a vinyl group, an acryl group, or a photosensitive derivative thereof.

14. The method of claim 13, wherein the organically modified Si-alkoxide is methacryloxypropyl tri-methoxysilane.

15. The method of claim 11, wherein the organically modified Si-alkoxide further comprises an epoxy group or an amine group.

16. The method of claim 15, wherein the organically modified Si-alkoxide is 3-glycidoxypropyl tri-methoxysilane.

17. The method of claim 11, wherein the metal atom (M) is selected from a group consisting of titanium (Ti), zirconium (Zr), germanium (Ge), tin (Sn), and cerium (Ce).

18. The method of claim 17, wherein the metal alkoxide comprises zirconium butoxide or zirconium proxide.

19. The method of claim 11, wherein the first solvent and the second solvent are identical, and the dielectric constants of the first solvent and the second solvent are less than about 10.

20. The method of claim 19, wherein the first solvent and the second solvent comprise tetra-hydrofuran or toluene.

21. The method of claim 11, wherein the third solvent comprises propylene glycol monoether acetate.

22. An organic-inorganic sol-gel material, the material comprising:
at least a functionalized nano-particle having at least a predetermined functional group, wherein the functionalized nano-particle is composed of a metal alkoxide and an organically modified Si-alkoxide, but excludes a chelating agent, wherein the metal alkoxide is formulated as M(OR)ₓ, and the organically modified Si-alkoxide has the predetermined functional group, and wherein M represents a metal atom with an un-saturation degree greater than zero, x is a valence of M, and R is a C₁-C₁₂ alkyl.

23. The material of claim 22, further comprising:
a solvent for dispersing the functionalized nano-particle, wherein the dielectric constant of the solvent is less than about 10.

24. The material of claim 23, wherein the solvent comprises tetra-hydrofuran, toluene, or propylene glycol monoether acetate.

25. The material of claim 22, wherein the metal atom (M) is selected from a group consisting of titanium (Ti), zirconium (Zr), germanium (Ge), tin (Sn), and cerium (Ce).

26. The material of claim 25, wherein the metal alkoxide comprises zirconium butoxide or zirconium proxide.

27. The material of claim 22, wherein the predetermined functional group comprises an unsaturated functional group.

28. The material of claim 27, wherein the unsaturated functional group comprises a vinyl group, an acryl group, or a photosensitive derivative thereof.

29. The material of claim 28, wherein the organically modified Si-alkoxide is methacryloxypropyl tri-methoxysilane.

30. The material of claim 22, wherein the predetermined functional group comprises an epoxy group or an amine group.

31. The material of claim 30, wherein the organically modified Si-alkoxide is 3-glycidoxypropyl tri-methoxysilane.
